(19) United States
(12) Patent Application Publication
(10) Pub. No.: US 2006/0224966 A1
(43) Pub. Date: Oct. 5, 2006

(54) Method of announcing a user of a computer and the activation and starting of several programs installed on a computer

(76) Inventor: Eberhard Bohn, Stockelsdorf (DE)

Correspondence Address: WALTER OTTESEN, PO BOX 4026, GAITHERSBURG, MD, 20885-4026, US

(21) Appl. No.: 11/372,188

(22) Filed: Mar. 10, 2006

(30) Foreign Application Priority Data
Mar. 30, 2005 (DE) 10 2005 014 405.5

(51) Int. Cl. G06F 3/00

(52) U.S. Cl. 715/733

(57) ABSTRACT

A method for logging on as a user of a computer, the activation and the starting of several programs installed on the computer, which are used to execute work programs used by the user of the computer and controlled via a processor and with which after booting, the work on the computer is begun by interaction with an input unit and a monitor. In the method, work programs (AP1, AP2), which were used by the user in the user's past work on the computer, are stored with an assigned flag as a configuration signal in a configuration memory. The stored programs (AP1, AP2) are called up after log-on by the user and the stored programs (AP1, AP2) are combined to a workplace icon. The icon is displayed on a monitor (BS) with the stored programs (AP1, AP2) being displayed in such a manner that the stored programs define a purposeful display as the icon and thereby indicate that the icon represents a combination which has been successful up to now and corresponds to the work habits of the user.

### CROSS REFERENCE TO RELATED APPLICATION

This application claims priority of German patent application no. 10 2005 014 405.5, filed Mar. 30, 2005, the entire content of which is incorporated herein by reference.

### BACKGROUND OF THE INVENTION

A method for configuring monitors is disclosed in German patent publication 198 09 952 A1. With this method, user-specific representations of display parameters can be realized. To avoid a repeated manual configuration, the user-specific monitor configuration data are stored on a storage medium. The configuration data are preferably called up from the storage medium during the system start and are read into the monitor. The assembly of the individual elements to the total configuration takes place, however, separately from the call-up of an application program and must be adjusted by the user during his activity on the monitor depending upon requirement or necessity and has to be stored. For a change of the user from one monitor to another, for example, at another workstation, the storage medium functions simply to take along the previously set configuration and to read this configuration into the memory at the new monitor so that the user's known configuration is again directly available to the user.

In a further arrangement disclosed in German patent publication 196 25 410 A1, via the deposit of a user-specific data record onto a storage medium, a medical diagnostic unit can be completely configured via the recourse to the data record. It is not necessary to always undertake repeating manual settings. This arrangement likewise has the disadvantage that, for establishing the user-specific settings, the user first must determine the settings which concern him and store these settings on the memory location provided for him.

The known state of the art has the further disadvantage that the user must himself change his previous configuration when the application configuration changes, for example, by changing requirements for therapy. For this purpose, the user has to call up the configuration parameters and to check which of the parameters has to be adjusted in which manner. In general, the user of a computer encounters the situation that all user settings have to be inputted by hand and are stored at a storage location provided therefor. The computer can be at home or at the work place as a PC or can be a computer unit having control processors for a technical apparatus. This relates to not only so-called configuration settings which concern the operation of the computer itself (so-called user accounts) but also the nature and the combination of the application programs with which the user carries out his work on the computer/PC. In most applications, the computer user has a standard combination of application programs which are opened after running up the computer in order to work therewith. These programs are, for example, programs such as the internet explorer, the e-mail program, the connection to the telephone network or to a like data network, the connection to a local network (LAN: Local Area Network) and additional programs which are assembled in accordance with the user's personal user habits. This assembly is, however, not constant for all times. Instead, depending upon the work task or dependent upon his communication in the internet or within the WLAN, other programs can be added and programs used to date are not needed. For example, for telephoning via the internet use can be made of an often-used application program (for example, Skype®). Instead of entering the newly used program manually into a list of application programs to be started in the storage medium provided therefor, it is desirable to permit the application of the programs to be checked or to be registered by the computer. In the state of the art, the actualization or a change of his work configuration desired by the user is always inputted manually or at least in accordance with his own action into the memory medium provided therefor. If the user has, for example, opened the mail program MS-Outlook®, it is closed when shutting down and run down. For a later run up (booting) of the computer, it is possible to have the program MS-Outlook® in the Office list as an icon, but the program must first be started for processing by clicking on the icon. If several programs were closed during switch off, which should be again started operationally ready after run up, this can mean a considerable burdensome expenditure of time.

### SUMMARY OF THE INVENTION

It is an object of the invention to improve a method of the kind described initially herein so that the user no longer has to be concerned as to which configuration has been proven to be the suitable application of a computer for that person and that the user, when changing his application habits, no longer needs to undertake a corresponding configuration change.

In a method of the kind described above, the application program used by the operator is transmitted by a flag, which characterizes the program, as a switching pulse to a configuration memory and registered. For each application program, a characterizing flag exists. When switching off the computer, the combination of the flags is stored and when running up the computer anew (booting), the flag combination from the memory is also run up and the application programs, which are assigned to the individual flags, are opened operationally ready and ready for application so that they are immediately available to the operator for his work.

In an advantageous configuration of the method, the flags and the corresponding programs are displayed as an image combination on the screen.

In a further embodiment of the invention, the user can select from a plurality (at least two) of different application configurations, those with which his computer is to be started after the booting.

In this way, different flag combinations with their own and different image representations can be brought together to a new total unit and this in such a manner that the combination thereof is represented in a new purposeful assembly from which the user can use the work programs suitable for him.

A computer is equipped with a configuration memory in its process architecture. This configuration memory stores the configuration of the programs used by the user in such a manner that, when booting the computer, the executable programs, which are used by the user, are started and carried out (*.eke/executable programs).

The advantage of the invention is that with a selective switching pulse, the last stored use setting of the user is called up. The user can continue with the operation of his computer with those executable programs where he had previously ended. For a renewed booting, these supplemented programs or the changed program combination are opened actively use ready and the list of the used programs is automatically made current.

The selection or activation of the use configuration replaces, in a simple manner, the tedious resetting of the configuration before the last switch off. Here, it is inconsequential whether the start configuration to be reestablished was the one which had directly preceded or whether it is such a start configuration which had been used some time ago or before multiple changes of the applied start situation.

The configuration memory can store a plurality of configuration variations from which the desired variation can be selected. This is especially an advantage when, several users with different application interests work on one computer or when a single user pursues different use purposes. This is, for example, the case when research is carried out at a computer on the internet and another user or another application is interested in the editing of text documents.

There are arrangements in existence which enable the user to arrange a so-called user portal for his computer. These portals are generally known, for example, as “My Google” because they make possible the personal arrangement of specific configurations from an application program (here, Google®). This personal configuration is, however, limited to the once arranged configuration similar to the configuration of a Windows Word setting for the image screen mask or the template (word.dot-file). The known memory arrangements for detecting user-defined settings cannot (as it is provided in the present invention) provide a change of the program configuration on their own; instead, they must be changed by actions of the user. The program configuration must be modified independently of the actual use settings of a computer sitting and applies from then on for all following sittings until it is arranged anew.

In the present invention, the configuration memory can store each individual configuration of a sitting changed in the past and, depending upon the requirement, can be activated by the user irrespective of whether the last-valid or any desired previously used configuration is selected.

In another variation, the individual components of a configuration are stored and offered to the user individually in the form of a menu or image representations (icons) so that he can select from this offer those icons which are most suitable for his upcoming sitting.

The configuration memory can contain an application counter which collects and indicates the frequency of the applied configuration or its components. From the indicated frequency, the user can select those configurations or components which appear most suitable for the planned sitting. Alternatively, the configuration memory can select an adjustable number of the most frequent components from the application counter and offer those as a proposal of a configuration to be applied to the user.

The user can select from one or several suggestions which one he actually wants to use. The configuration memory can, however, also offer a suitable configuration corresponding to the frequency of the application of individual components last used or entire configurations as a standard suggestion. The user can confirm this or can modify and thereafter apply different application components via a change/selection.

The criteria for the frequency of an application can exhibit different features: in the simplest case, it is the number of applications of a program per unit of time; in a more difficult case, it is the number of successfully solved tasks with an execution program selected for that purpose. For example, the correctness of a solved computation task or approximation computation at the end of an execution operation is confirmed as free of error by the user, a flag for the application program, which forms the basis for the computation, is set and supplied to the configuration memory as a configuration signal. In renewed computation tasks, the utilized application program, which has already been successful, is loaded and offered for this program via an image presentation on the monitor suitable.

The configuration setting on the configuration memory can be loaded onto an alternating memory medium such as a flash memory having USC connection or a floppy disk in order to take over the settings from a first computer and transmit the same to another computer.

A special simplification of the invention is that a preselection of programs for an office application with the computer is assembled and offered to the user. With a colored assembly of executable programs, for example, on the monitor (data expansion *.exe at Microsoft®) for work as an office computer, a selection is offered which contains a write program, a drawing program and a table calculation program. The colored assembly can comprise a yellow margin which encloses the offered programs. Or, the programs are so combined on the monitor in the form of their assigned icons that they are shown like a puzzle in a total unit image and are assembled to a form unit which represents a writing desk in order to show that the concern is with an assembly of programs for office work. Another assembly would be a program assembly of an internet browser, a program for connecting to the internet and an e-mail program. This assembly is, for example, enclosed by a yellow margin or the icons of the individual programs are so put together that they can be displayed as a completed globe. The advantage of this embodiment is that the user only has to select the assembled icon in order to start the total bundle of executable programs contained therein and so the computer is ready with only one mouse click with all needed executable programs for working on the computer.

In a further embodiment, it is provided that the program assembly is configured in the form of a puzzle-like assembly of the total icon in such a manner that the individual icons, which characterize an application program, have a structured contour in their outer margin. The margins exhibit, for example, indents, projections or roundings. The contours are adapted to the contours of the selected other icons so that several contours of different icons, which fit to each other, can be placed one next to the other without intermediate spaces or gaps at neighboring contours. If this is the case, then the application programs, which belong to the fittingly-formed icons, are suitable to form a combination of application programs wanted by the user (for example, Windows Office programs) which make possible an office application. The icons, which fit to each other, form then a total contour which is similar, for example, to a writing desk. Each application program then has, similar to a key lock system, a fitting combination with other icons belonging to the same system so that the user can put together a usable combination suitable for him individually. This combination is then stored in the configuration memory and can be, after booting of the computer, collectively selected by the user so that when clicking, the complete combination of executable user programs is opened and is available. The computer can also be so programmed that, after booting, the fitting combination of application programs used last is started without their having to be activated by the user by, for example, clicking with the mouse key.

A still further simplification of the invention is when the puzzle-like assembly is assigned a letter or an otherwise simple symbol which is clicked by the user, in order to start the entire bundle of executable programs.

Finally, the opening of documents from an executable program can be simplified when the programs needed therefor are already operationally ready when booting. The sequence of steps to be gone through is shortened. When running up the computer, the Word program is already operationally ready and the user need only click on the document in order to open it.

### BRIEF DESCRIPTION OF THE DRAWINGS

The invention will now be described with reference to the drawings wherein:

FIG. 1 is a schematic of a computer connected to a monitor and keypad;

FIG. 2 is a schematic showing how individual icons can be used for a program assembly; and,

FIG. 3 is an embodiment for an arrangement of icons in the form of puzzle-like margins.

### DESCRIPTION OF THE PREFERRED EMBODIMENTS OF THE INVENTION

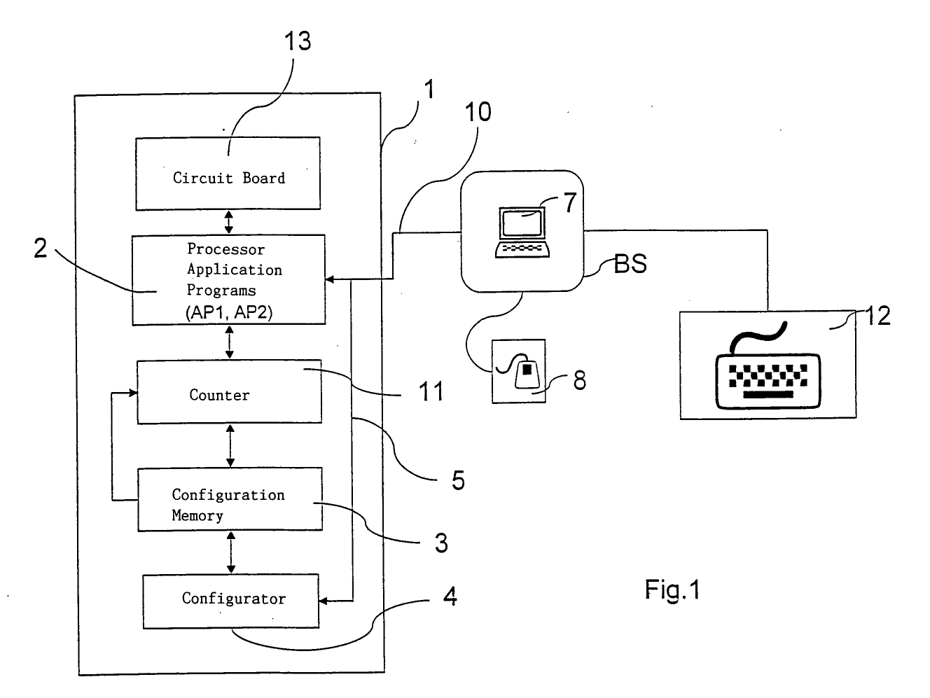

In FIG. 1, a computer 1 has a main circuit board HP and a processor 2 and a configuration memory 3 having a configurator 4 embedded therein. The configurator receives a configuration signal 5 of each executable application program (AP1, AP2), which is loaded in the processor, via a signal line 6. The executable program (AP1, AP2) is started by clicking an icon 7 via a mouse as an input unit 8 or a keypad 12. The icon 7 is shown on the monitor BS of the computer 1. The application program is started via a program line 10 by the processor 2. At the same time with the start of the application program AP1, the configuration signal 5 is conducted to the started program AP on the configurator 4 by the operational control of the processor 2. The configurator 4 stores the identifier of the started application program AP in the configuration memory 3 and increments a counter 11 in the memory 3 by one counter point. In the same manner, all additional call ups of the first application program AP1 are counted. If a second application program AP2 is called up, the storage of its activation runs in the same manner as with the application program AP1. If the computer 1 is switched off, the application programs (AP1, AP2) and their corresponding activation count of the counter 11 and the program type remain stored in the configurator 4. With a renewed booting of the computer 1, the configurator 4 and the counter 11 are enquired of in the boot program of the computer 1 and the contents are taken over so that the processor 2 starts the accessed application programs (AP1, AP2). The executable data (*.exe), which belong to the application programs (AP1, AP2), are started. The user has the programs, which were last applied by him, and the corresponding documents available for work. If, in one case, the application program AP1 is an internet browser with the establishment of a mail service provider and the application program AP2 is a mail program, then the icons for the programs (AP1, AP2) are shown to the user when running up his computer 1 on the screen BS and the two corresponding executable programs “browser.exe” and “mail.exe” are started by the boot program. On the screen BS, the user then sees the processing window of the e-mail program AP2 and obtains an online access to the internet via the started internet browser AP1. He can then directly start to write his e-mail and to send it via the internet to the receiver. He does not have to start individually each application program (AP1, AP2) and wait until the processing window of the e-mail is opened and the browser has switched on the internet line as one would have to do in a configuration without the features of the present invention.

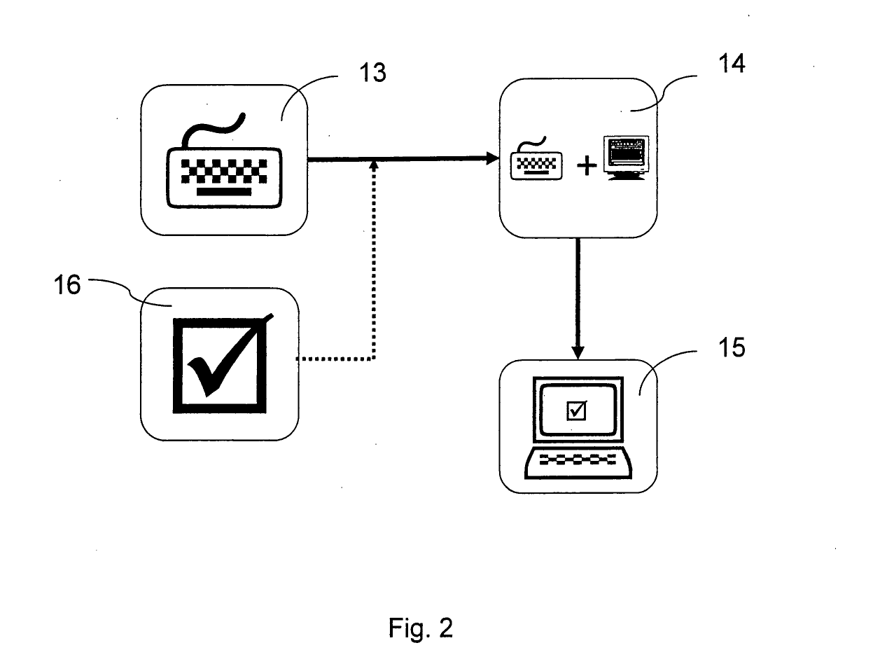

In FIG. 2, it is shown how individual icons can be used for a program assembly in order to display that the computer 1 is ready for an office application in that all programs, which are used for this purpose by the user, are loaded and are ready. A write icon 13 assembles the flags of the configuration signal 5 and assembles the executable programs, which are required for the write program, for the user. A drawing icon 14 includes all those flags of the configuration signal 6 which belong to those execution programs which make possible a graphic drawing with the computer. The combination of both icons (13, 14) is assembled to a workplace icon 15 which has an image representation of a computer which, without interruption of the line or without the indication of gaps, forms a unit which is closed upon itself so that the user is certain to find correctly fitting combinations for the application of his tasks. A further computation icon 16 is likewise offered to the user which offers the flags of the configuration signal of all computation programs which were up to now successful. If the user selects, in a second step, this computation icon 16 for a combination with the remaining icons (13, 14), it appears in the workplace icon 15 likewise in its center. The icons can exhibit all conceivable purposeful representation forms. In the simplest case, they can be number combinations which can be put together by the user himself.

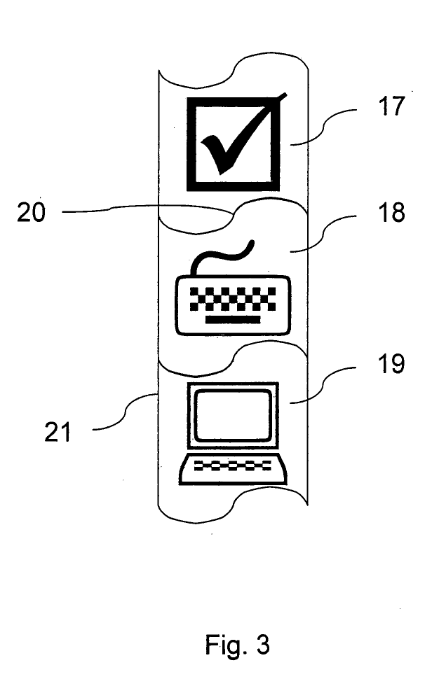

In FIG. 3, an embodiment is shown for the arrangement of the icons in the form of puzzle-like enclosing margins. Suitable executable programs according to FIG. 2 with their icons have a configuration of their margins such that they can be either put together separately by the user so that they form a total unit or the configuration memory 3 can display the corresponding icons as a unit on the monitor BS. In this way, a puzzle-like computation icon 17 is combined with a puzzle-like write icon 18 and a puzzle-like monitor icon 19 at their particular interface lines 20 to a corresponding margin 21. One such fitting arrangement of the icons (17, 18, 19) shows to the user that he has available an operationally ready total assembly of application software.

It is understood that the foregoing description is that of the preferred embodiments of the invention and that various changes and modifications may be made thereto without departing from the spirit and scope of the invention as defined in the appended claims.

What is claimed is:

1. A method for logging on as a user of a computer, the activation and the starting of several programs installed on the computer, which are used to execute work programs used by the user of the computer and controlled via a processor and with which after booting, the work on the computer is begun by interaction with an input unit and a monitor, the method comprising the steps of:
storing work programs (AP1, AP2), which were used by the user in the user's past work on the computer, with an assigned flag as a configuration signal in a configuration memory;
calling up the stored programs (AP1, AP2) after log-on by the user; and,
combining the stored programs (AP1, AP2) to a workplace icon and displaying the icon on a monitor (BS) with the stored programs (AP1, AP2) being displayed in such a manner that the stored programs define a purposeful display as the icon and thereby indicate that the icon represents a combination which has been successful up to now and corresponds to the work habits of the user.

2. The method of claim 1, comprising the further steps of:
providing a counter;
causing the counter to set a flag when starting the executable application programs (AP1, AP2) with the flag being detected by the counter;
characterizing the frequency of occurrences and the nature of the application programs; and,
storing the flags in the configuration memory.

3. The method of claim 1, comprising the further steps of:
providing an input unit for the user;
selecting the application programs (AP1, AP2) via said input unit with which the user works; and,
with the selection, setting the flag via the configuration signal which is stored in the configuration memory.

4. The method of claim 1, wherein the application programs (AP1, AP2) are represented by several icons which exhibit a puzzle-like periphery and are combined to a total image as an icon.

5. The method of claim 1, comprising the further steps of:
providing an input unit for the user;
simultaneously starting and executing all work programs (AP1, AP2) by activating the workplace icons via said input unit, the work programs (AP1, AP2) being represented in the workplace icons by the combined icons.

6. The method of claim 2, comprising the further steps of:
causing the counter to take up the frequency of the use of the work programs (AP1, AP2) as a flag; and,
transmitting the flag to the configuration memory.

7. The method of claim 2, comprising the further steps of:
causing the counter to take up the number of error messages in the programs (AP1, AP2) as a flag;
transmitting the flag as a configuration signal to the configuration memory; and,
reading out the configuration signal when booting the operating program of the computer.

8. The method of claim 1, comprising the further steps of:
causing the processor to read out the configuration memory when booting the operating program;
executing the work programs (AP1, AP2) stored in the configuration memory and displaying the workplace icons on the monitor.

9. The method of claim 1, comprising the further steps of:
causing the processor to read out the configuration memory when booting the operating program;
executing those work programs (AP1, AP2) from the configuration memory with the least number of error messages and displaying the workplace icons on the monitor.

10. The method of claim 1, comprising the further step of:
causing the opened activated work programs (AP1, AP2) to simultaneously display in a list, the documents opened with the particular work programs (AP1, AP2).
